(19) United States
(12) Patent Application Publication
(10) Pub. No.: US 2008/0169644 A1
(43) Pub. Date: Jul. 17, 2008

(54) Pipe Connector for Sectional Display Stand

(76) Inventor: Yong Rae Kim, Gyeonggi-do (KR)

Correspondence Address: DEFILLO & ASSOCIATES, INC., P.O. Box 14104, Clearwater, FL, 33766, US

(21) Appl. No.: 11/885,650

(22) PCT Filed: Mar. 3, 2006
(86) PCT No.: PCT/KR2006/000747

§ 371 Date: Sep. 4, 2007

(30) Foreign Application Priority Data
Mar. 4, 2005 (KR) 10-2005-0018237

(51) Int. Cl. F16L 39/00; A47B 96/00

(52) U.S. Cl. 285/120.1

(57) ABSTRACT

The present invention relates to a pipe connector for a sectional display stand, and the pipe connector includes: a first coupler having two to four insertion bars adapted to be inserted into pipes at one ends thereof and a central body adapted to connect the other ends of the insertion bars as a unitary piece thereto; a second coupler having two to four insertion bars adapted to be inserted into pipes at one ends thereof and a central body adapted to connect the other ends of the insertion bars as a unitary piece thereto; a screw through-hole formed on the central body of the first coupler; and an adjusting screw adapted to be mounted at the screw through-hole in such a manner as to be oriented toward the second coupler.

### TECHNICAL FIELD

The present invention relates to a pipe connector for a sectional display stand, and more particularly, to a pipe connector for a sectional display stand that can allow the assembly/disassembly of the sectional display stand to be conducted with ease, ir-respective of the sizes of the inner diameters of pipes used thereof, make the structure of the sectional display stand rigidly formed, and permit the pipes disassembled from the sectional display stand to be repeatedly used several times.

### BACKGROUND ART

A sectional display stand that is generally known as a trademark “Combilock” is produced in such a manner that a stainless or aluminum pipe is first cut at an appropriate length and the cut pipes are then assembled by using connectors, thereby forming the display stand in a desired shape. The sectional display stand has some advantages in that the installation and disassembly are relatively easy, the whole weight is light so that moving to another places is simple, and especially the display stand is readily changed into newly desired shapes in its structure and size. Thus, the sectional display stand has been widely used for interior decorations, and product displays or exhibitions.

The sectional display stand is comprised of pipes and connectors. The pipe is made of a metal or plastic steel pipe constituting the framework of the sectional display. The connector has a structure where two to five insertion bars are protrudingly formed in a vertical relation with one another, such that the pipe is insertably fit to the insertion bar at the both ends thereof, thereby connecting the two or more pipes with each other. The connector has two to five-branched types according to the number of pipes connected thereto, i.e., the number of insertion bars, and has linear-connected, right-angled-connected, plane-connected, and solid-connected types according to the structure of the insertion bars.

According to the conventional sectional display stand, however, the insertion bars of each connector are forcedly inserted into the pipes for fixing the pipes thereat, such that if the outer diameter of each insertion bar accurately does not coincide with the inner diameter of each pipe, it is very difficult to connect the pipes with the insertion bars, and thus, when the insertion bars are not firmly inserted into the pipes, un-desirably, the display stand has a loose structure. More particularly, in case where the pipes are used again after disassembling, the inner peripheries of the pipes are damaged or expanded to a given degree, such that when the pipes are used again, the display stand has a week structure.

To solve these problems, thus, there is provided Korean Utility Model Registration No. 357303 filed by the same applicant as of this invention wherein a pipe joint (which is designated as a pipe connector in this invention) for a sectional display stand that can expand or contract variably the diameter of an insertion pipe (which is designated as an insertion bar in this invention) adapted to be insertably fit to a pipe. The pipe joint can drastically improve the operability upon the assembling and disassembling of the pipes and also can keep the structure of the display stand greatly rigid even when the pipes are used again, thereby considering the pipe joint for a sectional display stand as one of very useful improvements in the industrial field.

Referring to the structure of the conventional pipe joint for the sectional display stand, the pipe joint is a solid five-branched connector that has four horizontal insertion pipes disposed in one plane and one vertical insertion pipe disposed in a vertical direction with respect to the four horizontal insertion pipes, wherein the diameter of each horizontal insertion pipe is adjusted by the size of a gap between a first coupler and a second coupler and the diameter of the vertical insertion pipe is adjusted by the forward or backward movement of a screw member. Thus, the diameters of the five horizontal and vertical insertion pipes are all adjusted by means of one screw member, such that if the diameters of all of the five insertion pipes are not expanded to a given constant degree, the insertion pipes that have been expanded in the diameters to a relatively slow degree fail to firmly support the inner peripheries of the pipes. In other words, if some of the five insertion pipes are expanded in the diameters to support the inner peripheries of the pipes, the rest of the five insertion pipes that are not expanded yet to a degree supporting the inner peripheries of the pipes is not expanded anymore, which makes the sectional display stand substantially loose in the structure.

In addition, according to the conventional pipe joint for the sectional display stand, there is no means for binding the first coupler with the second coupler, which makes it inconvenient to use, and the pipe joint is not suitable in having two to four-branched structures, which causes a need for the improvement of the structure thereof.

### DISCLOSURE OF INVENTION

### Technical Problem

Accordingly, the present invention has been made to solve the above-mentioned problems occurring in the prior art, and it is an object of the present invention to provide a pipe connector for a sectional display stand that can allow the assembly/disassembly of the sectional display stand to be conducted with ease, irrespective of the sizes of the inner diameters of pipes used thereof, make the structure of the sectional display stand rigidly formed, and permit the pipes disassembled from the sectional display stand to be repeatedly used several times.

### Technical Solution

To accomplish the above object, according to an aspect of the present invention, there is provided a pipe connector for a sectional display stand including: a first coupler having two to four insertion bars adapted to be inserted into pipes at one ends thereof and a central body adapted to connect the other ends of the insertion bars as a unitary piece thereto, the first coupler having a screw through-hole formed on the central body thereof; a second coupler having two to four insertion bars adapted to be inserted into pipes at one ends thereof and a central body adapted to connect the other ends of the insertion bars as a unitary piece thereto; and an adjusting screw adapted to be mounted at the screw through-hole in such a manner as to be oriented toward the second coupler.

According to the present invention, preferably, the two insertion bars are disposed in a linear direction or in a direction perpendicular to each other.

According to the present invention, preferably, the three insertion bars are disposed in the directions of X, Y, and Z axes with respect to one another, or are disposed in one plane at an angle of 60° with respect to one another.

According to the present invention, preferably, the four insertion bars are disposed in the directions of X, Y, and Z axes with respect to one another, or are disposed in one plane at an angle of 90° with respect to one another.

To accomplish the above object, according to another aspect of the present invention, there is provided a pipe connector for a sectional display stand including: a first coupler having three to four horizontal insertion bars disposed in one plane at a given angle to one another in such a manner as to be inserted into pipes at one ends thereof and a central body adapted to connect the other ends of the horizontal insertion bars as a unitary piece thereto, the central body having a screw through-hole formed therein; a second coupler having three to four horizontal insertion bars disposed in one plane at a given angle to one another in such a manner as to be inserted into pipes at one ends thereof and a central body adapted to connect the other ends of the horizontal insertion bars as a unitary piece thereto; a vertical insertion bar formed on the central body of the second coupler in such a manner as to be disposed in a vertical direction with respect to the horizontal insertion bars of the second coupler; a plurality of slits formed longitudinally at the end portion of the vertical insertion bar; an insertion groove formed in an axial direction with respect to the vertical insertion bar at the inside of the second coupler, the insertion groove having an inclined portion formed narrower in diameter thereof at the end portion thereof in such a manner as to be connected to the plurality of slits; and an adjusting screw bar adapted to be mounted at the screw through-hole and the insertion groove, the adjusting screw bar having an inclined portion formed at the end portion thereof in such a manner as to insertably fit to the inclined portion of the insertion groove.

### ADVANTAGEOUS EFFECTS

This invention discloses a pipe connector for a sectional display stand that can allow the assembly/disassembly of the sectional display stand to be conducted with ease, irrespective of the sizes of the inner diameters of pipes used thereof, make the structure of the sectional display stand rigidly formed, and permit the pipes dis-assembled from the sectional display stand to be repeatedly used several times, such that the pipe connector of this invention can be very useful in various industrial fields.

### BRIEF DESCRIPTION OF THE DRAWINGS

FIG. 1 is a sectional view showing a right-angled two-branched connector according to an embodiment of the present invention;

FIG. 2 is an assembled perspective view showing a solid three-branched connector according to another embodiment of the present invention;

FIG. 3 is a dissembled perspective view showing the solid three-branched connector of FIG. 2;

FIG. 4 is a plane view showing a plane three-branched connector according to still another embodiment of the present invention;

FIG. 5 is an assembled perspective view showing a solid four-branched connector according to yet another embodiment of the present invention;

FIG. 6 is a dissembled perspective view showing the solid four-branched connector of FIG. 5;

FIG. 7 is an assembled perspective view showing a solid five-branched connector according to still yet another embodiment of the present invention;

FIG. 8 is a dissembled perspective view showing the solid five-branched connector of FIG. 7; and

FIG. 9 is a dissembled sectional view showing the solid five-branched connector of FIG. 7.

### BEST MODE FOR CARRYING OUT THE INVENTION

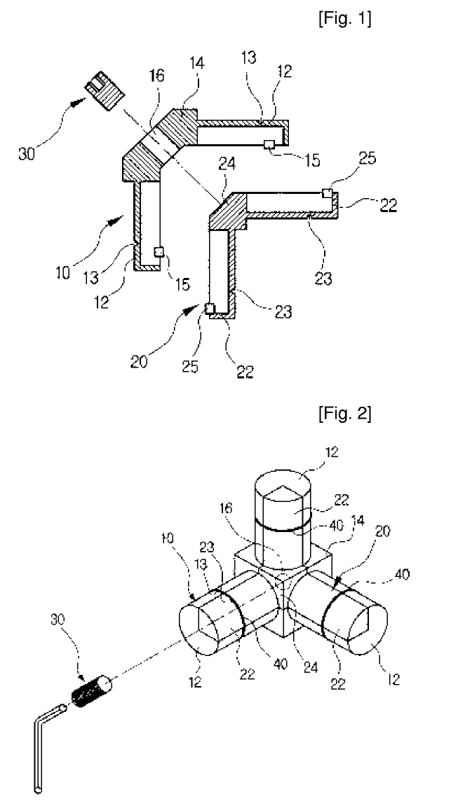

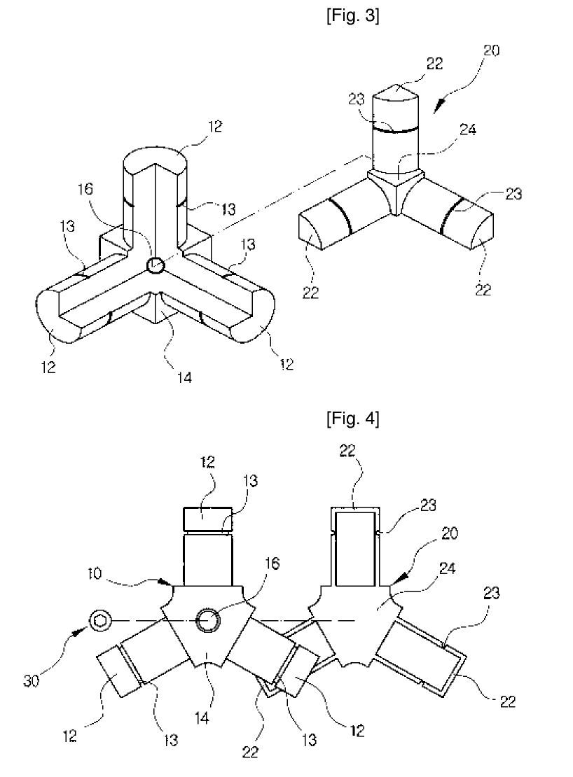

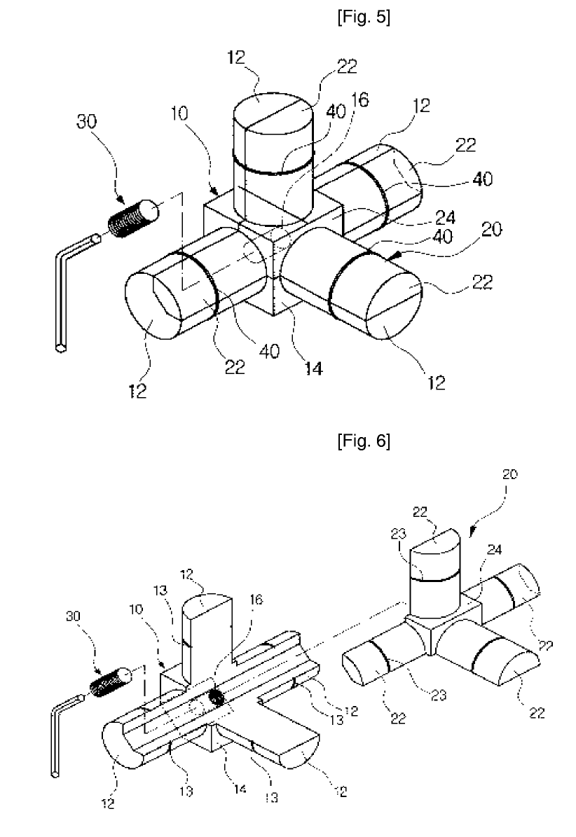

FIG. 1 is a sectional view showing a right angle two-branched connector according to an embodiment of the present invention, wherein two insertion bars are disposed in the direction perpendicular to each other, FIG. 2 is an assembled perspective view showing a solid three-branched connector according to another embodiment of the present invention, wherein three insertion bars are disposed in the directions of X, Y, and Z axes, FIG. 3 is a dissembled perspective view showing the solid three-branched connector of FIG. 2. Further, FIG. 4 is a plane view showing a plane three-branched connector according to still another embodiment of the present invention, wherein three insertion bars are disposed in one plane at an angle of 60° to one another, FIG. 5 is an assembled perspective view showing a solid four-branched connector according to yet another embodiment of the present invention, wherein four insertion bars are disposed in the directions of X, Y, and Z axes, and FIG. 6 is a dissembled perspective view showing the solid four-branched connector of FIG. 5.

As shown in FIGS. 1 to 6, the pipe connector for a sectional display stand according to the preferred embodiments of the present invention includes a first coupler 10, a second coupler 20, and an adjusting screw 30. At this time, the first and second couplers 10 and 20 have a plurality of insertion bars 12 and 22 adapted to be inserted into one ends of pipes (which are not shown) and central bodies 14 and 24 connecting one ends of the insertion bars 12 and 22 as a unitary piece. Each of the insertion bars 12 of the first coupler 10 and each of the insertion bars 22 of the second coupler 20 are desirably formed of a generally hollow cylindrical shape in such a manner as to be in close contact with each other at respective one faces. At this time, a plurality of fitting protrusions 15 and 25 are desirably formed on any one of the contacted surfaces of the two insertion bars 12 and 22 or on the both surfaces thereof, for supporting the inner peripheries of the facing surfaces thereof to accurately position the two insertion bars 12 and 22 at a time of connecting each other.

After the first coupler 10 and the second coupler 20 have been in close contact with each other at their one faces, they are inserted into the pipes, and at this time, the boundary face formed by contacting the two insertion bars 12 and 22 with each other may be formed of a linear line, a semi-circle, or a right angle. Moreover, the insertion bars 12 and 22 have generally annular grooves 13 and 23 formed along the outer peripheral surfaces thereof in such a manner as to fit an O-ring 40 within each of the annular grooves, the O-ring 40 being formed of a silicon or rubber material. The O-ring 40 serves to bind the first coupler 10 and the second coupler 20 to each other such that they are not separated from each other, thereby making it convenient to use the connector, and at the same time serves to firmly support the insertion bars 12 and 22 onto the inner peripheries of the pipes.

According to the preferred embodiments of the present invention, the central body 14 of the first coupler 10 has a screw through-hole 16 formed at the center zone thereof in such a manner as to be coupled with the adjusting screw 30. Thus, if the adjusting screw advances by means of a wrench at a state where the insertion bars 12 of the first coupler 10 and the insertion bars 22 of the second coupler 20 are inserted into the pipes, the end of the adjusting screw 30 pushes the inside of the central body 24 of the second coupler 20 such that the first coupler 10 and the second coupler 20 are spaced apart. Thus, the gap between the insertion bars 12 and 22 becomes formed, thereby firmly supporting the inner peripheral surfaces of the pipes.

According to the preferred embodiments of the present invention, the insertion bars 22 of the second coupler 20 are operated like a seesaw as the end of the adjusting screw 30 acts as a support stand, such that the pushing force of the adjusting screw 30 is evenly distributed to all of the insertion bars 22, thereby enabling the pipes connected to the insertion bars 22 to be firmly supported thereon.

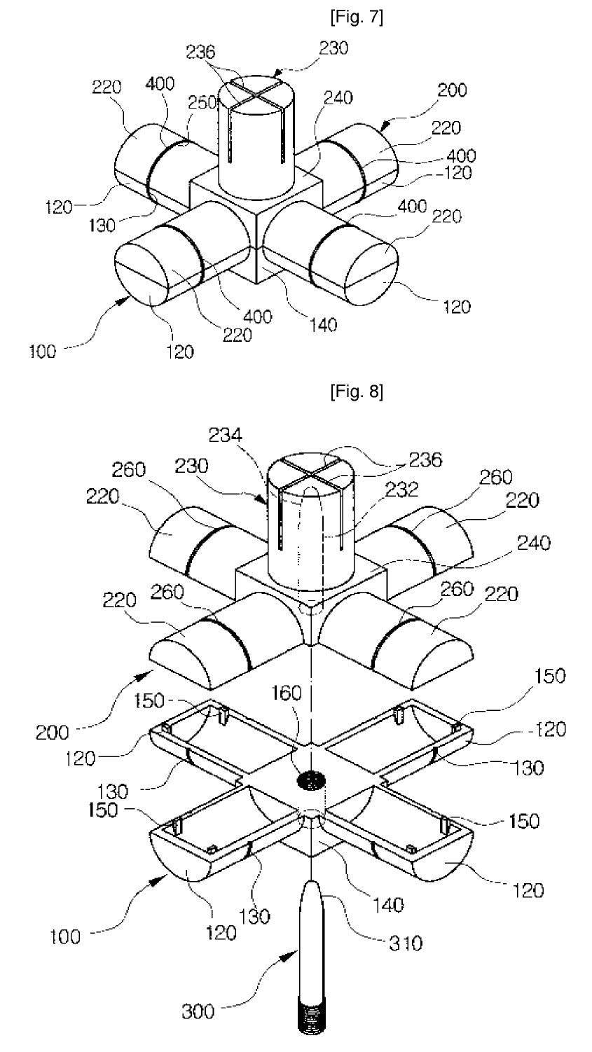

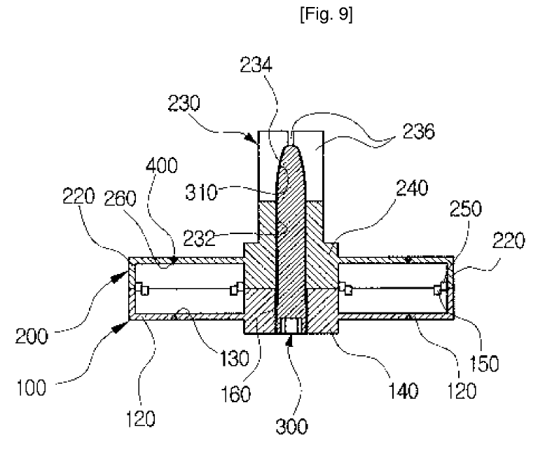

Furthermore, FIG. 7 is an assembled perspective view showing a solid five-branched connector according to still yet another embodiment of the present invention, wherein four horizontal insertion bars are disposed in one plane at an angle of 90° to one another and one vertical insertion bar is disposed in a vertical direction with respect to the horizontal insertion bars, FIG. 8 is a dissembled perspective view showing the solid five-branched connector of FIG. 7, and FIG. 9 is a dissembled sectional view showing the solid five-branched connector of FIG. 7.

As shown in FIGS. 7 to 9, the pipe connector for a sectional display stand according to the preferred embodiments of the present invention includes a first coupler 100, a second coupler 200, and an adjusting screw bar 300. At this time, the first coupler 100 has four horizontal insertion bars 120 and a central body 140 connecting one ends of the four horizontal insertion bars 120 as a unitary piece, the central body 140 having a screw through-hole 160 formed thereon, and the second coupler 200 also has four horizontal insertion bars 220 and a central body 240 connecting one ends of the four horizontal insertion bars 120 as a unitary piece, the central body 240 having one vertical insertion bar 230 disposed in a vertical direction thereto. The central body 240 of the second coupler 200 has an insertion groove 232 formed in an axial direction with respect to the vertical insertion bar 230 in such a manner as to communicate with the screw through-hole 160, and the vertical insertion bar 230 has a plurality of slits 236 formed on the end portion thereof in such a manner as to be cut longitudinally at the central body thereof. The adjusting screw 300 is inserted into the insertion groove 232 via the screw through-hole 160.

Each of the horizontal insertion bars 120 of the first coupler 100 and each of the horizontal insertion bars 220 of the second coupler 200 are desirably formed of a generally hollow cylindrical shape in such a manner as to be in close contact with each other at respective one faces. At this time, a plurality of fitting protrusions 150 and 250 are desirably formed on any one of the contacted surfaces of the two horizontal insertion bars 120 and 220 or on the both surfaces thereof, for supporting the inner peripheries of the facing surfaces thereof to accurately position the two horizontal insertion bars 120 and 220 at a time of connecting each other.

Moreover, the horizontal insertion bars 120 and 220 and the vertical insertion bar 230 have generally annular grooves 130 and 230 formed along the outer peripheral surfaces thereof in such a manner as to fit an O-ring 400 within each of the annular grooves, the O-ring 400 being formed of a silicon or rubber material. The O-ring 400 serves to bind the first coupler 100 and the second coupler 200 to each other such that they are not separated from each other, thereby making it convenient to use the connector, and at the same time serves to firmly support the horizontal insertion bars 120 and 220 and the vertical insertion bar 230 onto the inner peripheries of the pipes.

On the other hand, as shown in FIG. 9, the insertion groove 232 formed at the inside of the vertical insertion bar 230 has an inclined portion 234 formed narrower in diameter thereof at the end portion thereof in such a manner as to communicate with the slits 236, and the adjusting screw bar 300 has an inclined portion 310 formed at the end portion thereof in such a manner as to insertably fit to the inclined portion 234 of the insertion groove 232. Thus, if the adjusting screw bar 300 advances by means of a wrench at a state where the horizontal insertion bars 120 and 220 and the vertical insertion bar 230 are inserted into the pipes, the end of the adjusting screw bar 300 pushes the inner end of the insertion groove 232 such that the first coupler 100 and the second coupler 200 are spaced apart. Thus, the gap between the two horizontal insertion bars 120 and 220 becomes formed, thereby firmly supporting the inner peripheral surfaces of the pipes, and at the same time, the inclined portion 310 formed at the end portion of the adjusting screw bar 300 is forcedly inserted into the inside of the insertion groove 232 to push the inclined portion formed at the end portion of the insertion groove 232, thereby expanding the slits 236 to make the vertical insertion bar 230 larger in the outer diameter thereof.

According to the preferred embodiments of the present invention, the horizontal insertion bars 220 of the second coupler 200 are operated like a seesaw as the end of the adjusting screw bar 300 acts as a support stand, such that the pushing force of the adjusting screw bar 300 is evenly distributed to all of the horizontal insertion bars 220. Also, the inclined portion 310 formed at the end portion of the adjusting screw bar 300 and the inclined portion 234 formed at the end portion of the insertion groove 232 conduct appropriate idling, thereby making the force between the horizontal insertion bars 220 and the vertical insertion bar 230 balanced. As a result, all of the horizontal insertion bars 120 and 200 and the vertical insertion bar 230 enable the pipes connected thereto to be firmly supported thereon.

Further, a solid four-branched connector may be formed, using the same principles as the solid five-branched connector of this invention, wherein three horizontal insertion bars are disposed in one plane at an angle of 60° to one another, and one vertical insertion bar is disposed in a vertical direction to the horizontal insertion bars.

In addition to those connectors as shown in FIGS. 1 to 9 in the preferred embodiments of the present invention, the insertion bars are varied in number, angle, and structure thereof may be varied within the scope of the objects of this invention.

### INDUSTRIAL APPLICABILITY

This invention discloses a pipe connector for a sectional display stand that can allow the assembly/disassembly of the sectional display stand to be conducted with ease, irrespective of the sizes of the inner diameters of pipes used thereof, make the structure of the sectional display stand rigidly formed, and permit the pipes dis-assembled from the sectional display stand to be repeatedly used several times, such that the pipe connector of this invention can be very useful in various industrial fields.

1. A pipe connector for a sectional display stand comprising:
a first coupler having two to four insertion bars adapted to be inserted into pipes at one ends thereof and a central body adapted to connect the other ends of the insertion bars as a unitary piece thereto, the first coupler having a screw through-hole formed on the central body thereof;
a second coupler having two to four insertion bars adapted to be inserted into pipes at one ends thereof and a central body adapted to connect the other ends of the insertion bars as a unitary piece thereto; and an adjusting screw adapted to be mounted at the screw through-hole in such a manner as to be oriented toward the second coupler.

2. The pipe connector for a sectional display stand according to claim 1, wherein the two insertion bars are disposed in a linear direction or in the direction perpendicular with respect to each other.

3. The pipe connector for a sectional display stand according to claim 1, wherein the three insertion bars are disposed in the directions of axes X, Y, and Z with respect to one another, or are disposed in one plane at an angle of 60° with respect to one another.

4. The pipe connector for a sectional display stand according to claim 1, wherein the four insertion bars are disposed in the directions of axes X, Y, and Z with respect to one another, or are disposed in one plane at an angle of 90° with respect to one another.

5. The pipe connector for a sectional display stand according to claim 1, wherein each of the insertion bars has a generally annular groove formed along the outer peripheral surface thereof, and an O-ring is fit within the annular groove.

6. A pipe connector for a sectional display stand comprising:
a first coupler having three to four horizontal insertion bars disposed in one plane at a given angle to one another in such a manner as to be inserted into pipes at one ends thereof and a central body adapted to connect the other ends of the horizontal insertion bars as a unitary piece thereto, the first coupler having a screw through-hole formed on the central body thereof;
a second coupler having three to four horizontal insertion bars disposed in one plane at a given angle to one another in such a manner as to be inserted into pipes at one ends thereof and a central body adapted to connect the other ends of the horizontal insertion bars as a unitary piece thereto;
a vertical insertion bar formed on the central body of the second coupler in such a manner as to be disposed in a vertical direction with respect to the horizontal insertion bars of the second coupler; a plurality of slits formed longitudinally at the end portion of the vertical insertion bar; an insertion groove formed in an axial direction with respect to the vertical insertion bar at the inside of the second coupler, the insertion groove having an inclined portion formed narrower in diameter thereof at the end portion thereof in such a manner as to be connected to the plurality of slits; and an adjusting screw bar adapted to be mounted at the screw through-hole and the insertion groove, the adjusting screw bar having an inclined portion formed at the end portion thereof in such a manner as to insertably fit to the inclined portion of the insertion groove.

7. The pipe connector for a sectional display stand according to claim 6, wherein the horizontal insertion bars and the vertical insertion bar have a generally annular groove formed along the outer peripheral surfaces thereof, and an O-ring is fit within the annular groove.
